(19) United States
(12) Patent Application Publication
(10) Pub. No.: US 2026/0128902 A1
(43) Pub. Date: May 7, 2026

(54) System and Methods for Registering Virtual Entities Using Blockchain Technology

(71) Applicants: Siamak Goudarzi, Southampton (GB); Anita Papp, Southampton (GB)

(72) Inventors: Siamak Goudarzi, Southampton (GB); Anita Papp, Southampton (GB)

(21) Appl. No.: 19/377,195

(22) Filed: Nov. 3, 2025

Related U.S. Application Data
(60) Provisional application No. 63/717,005, filed on Nov. 6, 2024.

(51) Int. Cl. H04L 9/32; H04L 9/00

(52) U.S. Cl. CPC H04L 9/3236; H04L 9/3218; H04L 9/3247; H04L 9/3297; H04L 9/50

(57) ABSTRACT

A comprehensive system and method for registering, classifying, and governing Virtual Entities (VEs) using blockchain technology is disclosed. The system establishes a four-tier classification framework comprising Tools (VE-T), Agents (VE-A), Collaborators (VE-C), and Virtual Persons (VE-P), each distinguished by functional capabilities and autonomy levels. Each registered entity receives a unique, cryptographically secured digital identifier (VE-ID) incorporating jurisdictional codes, classification designators, temporal markers, and hash-based authentication. The platform provides comprehensive lifecycle tracking, immutable metadata storage, and optional governance integration through consent-based smart contracts that link external human guardians, organizational custodians, or collaborative partners. The invention implements decentralized identifiers (DIDs), zero-knowledge proofs (ZKPs), and secure application programming interfaces (APIs) to enable third-party verification, regulatory compliance, and cross-platform interoperability. This framework establishes transparent, ethically grounded, and legally verifiable infrastructure for the deployment and oversight of autonomous digital systems across multiple jurisdictions.

### CROSS-REFERENCE TO RELATED APPLICATIONS

This application claims the benefit of U.S. Provisional Ser. No. 63/717,005, filed on Nov. 6, 2024, titled “System and Methods for Registering Virtual Persons Using Blockchain Technology,” the entire contents of which are hereby incorporated by reference.

### FIELD OF THE INVENTION

The present invention relates to the fields of artificial intelligence governance, digital identity management, and decentralized registration systems. More specifically, the invention concerns a blockchain-based infrastructure for identifying, classifying, registering, and tracking artificial entities—including AI-powered tools, autonomous agents, collaborative systems, and virtual persons—throughout their operational lifecycle, from initial deployment through evolution, modification, and eventual deactivation.

### BACKGROUND OF THE INVENTION

The rapid advancement of generative artificial intelligence, autonomous agents, and self-improving digital systems has created a significant legal, ethical, and regulatory vacuum. While natural persons and legal entities such as corporations have well-established mechanisms for registration, accountability, identity verification, and governance oversight, intelligent digital systems currently lack equivalent standardized infrastructure. This absence creates substantial challenges for developers, regulators, end-users, and the broader public.

Existing approaches to AI system documentation focus predominantly on technical artifacts such as training data provenance, model architectures, output logging, or version control metadata. However, these approaches fail to address the entity itself as a persistent, identifiable actor within digital and legal ecosystems. There is presently no unified, scalable framework for defining, classifying, uniquely identifying, or comprehensively tracking the identity and lifecycle evolution of artificial digital entities across jurisdictions or operational contexts.

The absence of such infrastructure poses critical risks, including but not limited to: (a) insufficient transparency regarding system capabilities, limitations, and behavioural patterns; (b) difficulty in attributing legal or ethical responsibility for actions taken by autonomous systems; (c) inability to meaningfully distinguish between fundamentally different types and degrees of artificial intelligence autonomy; (d) challenges in enforcing emerging regulatory frameworks such as the European Union Artificial Intelligence Act; and (e) lack of mechanisms for establishing trust, provenance, and accountability in commercial AI deployments.

While various “Responsible AI” guidelines and principles have been proposed by academic institutions, industry consortia, and governmental bodies, these efforts have remained largely advisory, non-binding, and fragmented across organizational boundaries. Current proposals for digital identity systems (such as Decentralized Identifiers) and AI governance frameworks do not yet provide a comprehensive, technically robust, blockchain-verifiable, and legally cognizable system for registering, classifying, and managing the complete lifecycle of digital entities over extended time periods.

Therefore, there exists a substantial and unmet need for a standardized, transparent, and immutable registration system that can accommodate the full spectrum of artificial intelligence implementations—from simple computational tools to highly autonomous virtual persons—while providing the necessary infrastructure for regulatory compliance, ethical oversight, and public accountability.

### SUMMARY OF THE INVENTION

The present invention addresses the aforementioned deficiencies by providing a comprehensive blockchain-based system for the structured registration, classification, identification, and lifecycle management of Virtual Entities (VEs). The system enables consistent categorization, unique identity assignment, governance integration, and transparent tracking of intelligent digital actors throughout their operational existence.

The invention comprises the following key technical and functional elements: (a) Virtual Entity Identifier (VE-ID): A unique, cryptographically secured, blockchain-anchored digital identity assigned to each registered entity. The VE-ID incorporates jurisdictional information, classification designators, temporal markers, sequential numbering, and hash-based verification components to ensure global uniqueness and immutability. (b) Four-Tier Classification Model: A hierarchical taxonomy comprising four distinct categories based on functional capabilities, autonomy levels, and legal relevance: Tools (VE-T): Passive computational utilities or task-specific modules exhibiting deterministic behaviour without autonomous decision-making capabilities. Agents (VE-A): Semi-autonomous systems capable of executing predefined actions on behalf of human users or organizational entities within bounded operational parameters. Collaborators (VE-C): Co-creative or co-executive digital partners that engage with human users in shared decision-making processes, joint task execution, or collaborative content generation. Virtual Persons (VE-P): Highly autonomous, identity-persistent digital entities demonstrating advanced agency, adaptive learning capabilities, self-directed reasoning, and potentially expressible internal models of self and environment. (c) Dynamic Lifecycle Management: A comprehensive tracking system that monitors and records entity evolution through classification tiers, with mandatory governance checkpoints, verification requirements, and state transition protocols recorded immutably on the blockchain ledger. (d) Decentralized Storage Architecture: A distributed storage system employing cryptographic security measures to maintain entity records including model metadata, training provenance, governance structures, update history, risk assessments, operational logs, and compliance documentation. (e) Consent and Accountability Modules: Optional but recommended integration mechanisms allowing the cryptographic linking of human guardians, platform operators, organizational custodians, or collaborative partners to registered entities for purposes of oversight, consent management, and responsibility attribution.

The system provides numerous advantages over existing approaches: Establishes clear and transparent classification standards for intelligent systems across the autonomy spectrum. Creates durable, verifiable digital identities for AI-powered actors that persist across operational contexts and platform migrations. Facilitates regulatory oversight, compliance verification, and trust establishment for virtual entities deployed across diverse sectors and jurisdictions. Bridges existing legal gaps by providing a digital registration process functionally analogous to birth certificates for natural persons or incorporation documents for legal entities. Enables structured, ethical, and legally cognizable integration of artificial intelligence systems into societal, economic, and legal frameworks.

The invention thereby provides the essential technical infrastructure necessary for the responsible registration, governance, and evolutionary tracking of digital entities—spanning the complete range from temporary computational assistants to persistent virtual identities with long-term operational histories.

### BRIEF DESCRIPTION OF THE DRAWINGS

The accompanying drawings illustrate exemplary embodiments of the invention and assist in explaining its underlying principles and operational characteristics:

FIG. 1—System Overview Architecture: A schematic diagram depicting the core architectural components of the Virtual Entity Registration System, including the Classification Engine, Identity Generation Module, Blockchain Ledger Interface, Lifecycle Tracking System, Metadata Storage Infrastructure, and External Governance Integration Interface.

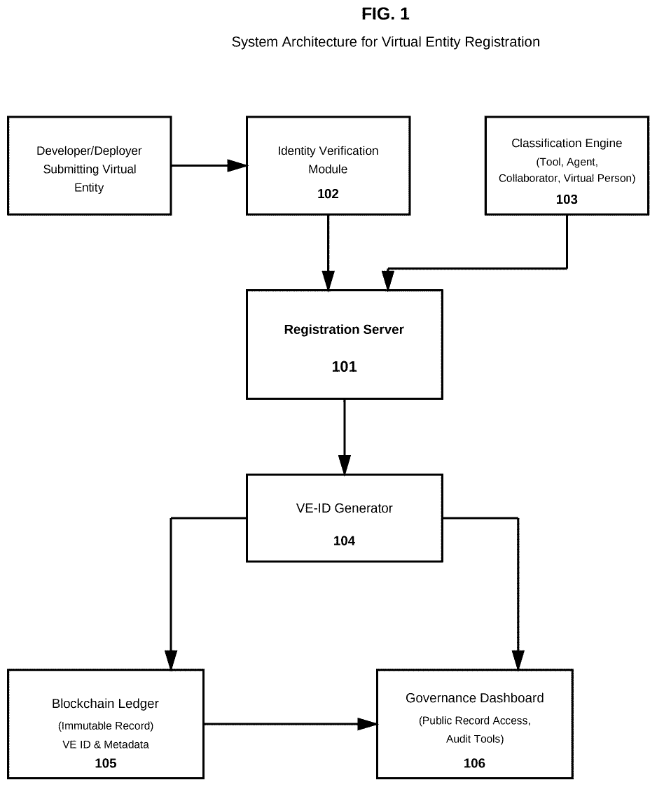

FIG. 2—VE Classification Model: A layered taxonomic diagram illustrating Virtual Entities categorized as Tools (VE-T), Agents (VE-A), Collaborators (VE-C), and Virtual Persons (VE-P), with directional arrows indicating possible tier transitions, upgrade pathways, and governance checkpoints.

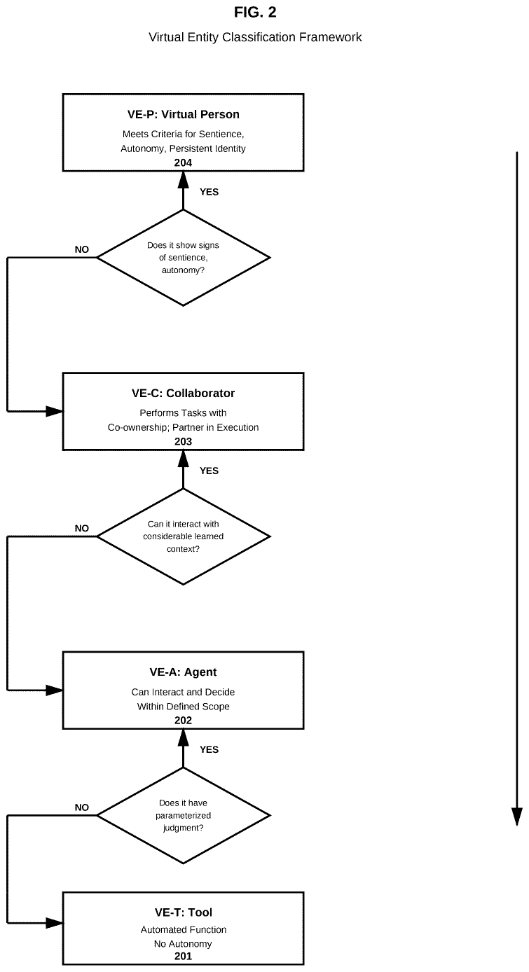

FIG. 3—VE-ID Creation and Blockchain Anchoring: A detailed flowchart depicting the procedural steps by which a newly instantiated Virtual Entity undergoes metadata analysis, classification determination, unique identifier generation, cryptographic signing, and anchoring to the blockchain ledger with consensus validation.

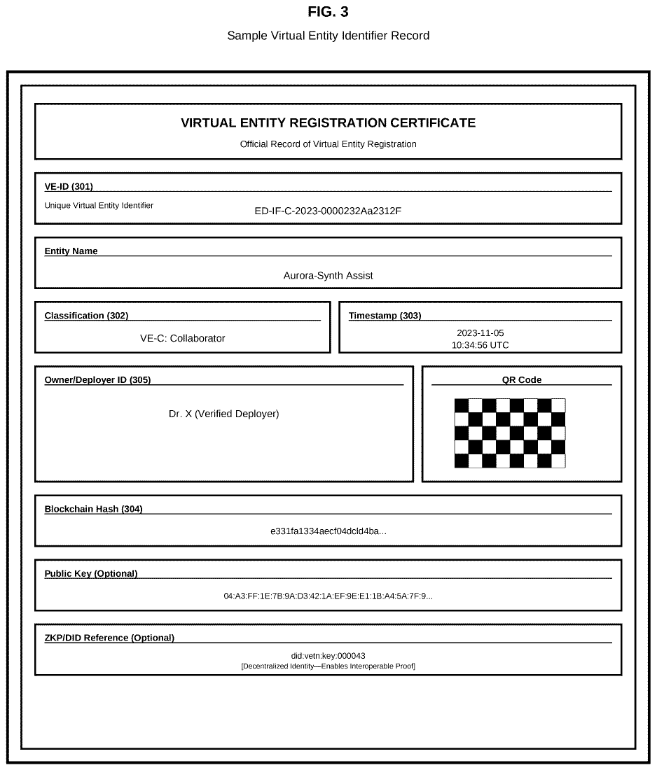

FIG. 4—Lifecycle Evolution of a Virtual Entity: A sequence diagram mapping the temporal progression of an entity through classification tiers, including governance verification checkpoints, human oversight integration points, update protocols, and state transition mechanisms.

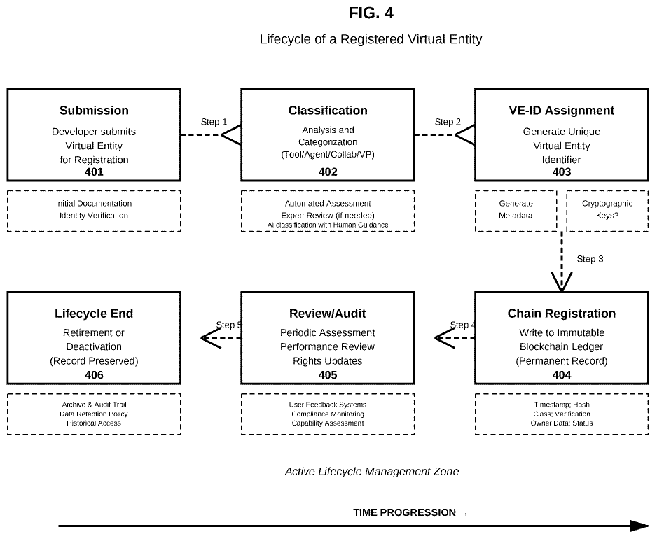

FIG. 5—Consent and Governance Integration Module: A structural diagram illustrating how external guardians, platform operators, or collaborative human actors are cryptographically linked to Virtual Entities through smart contracts, multi signature wallets, or consent management protocols to establish accountability chains.

FIG. 6—Digital Registration Card Interface: A mock-up representation of a registration certificate displaying essential elements including the unique VE-ID string, jurisdictional code, classification label, blockchain hash fingerprint, optional guardian signature field, issuing authority designation, and machine-readable QR code for public verification purposes.

### DETAILED DESCRIPTION OF THE INVENTION

### SYSTEM ARCHITECTURE OVERVIEW

The following detailed description illustrates exemplary embodiments of the invention. The terminology employed herein is selected for clarity and descriptive precision and is not intended to limit the scope of the invention as defined in the appended claims.

System Overview and Core Components. The invention provides a distributed, blockchain-based platform for creating, recording, managing, and verifying Virtual Entities (VEs) throughout their operational lifecycle. The system architecture comprises multiple interconnected modules operating in coordination to ensure data integrity, security, and regulatory compliance.

Each registered entity is assigned a unique Virtual Entity Identifier (VE-ID) that serves as a persistent, immutable reference linking comprehensive metadata, governance attributes, operational history, compliance documentation, and audit trails within the blockchain ledger. The system architecture enables secure verification, real-time status queries, lifecycle state tracking, and cross-jurisdictional interoperability through standardized protocols and application programming interfaces (APIs).

### CLASSIFICATION FRAMEWORK

Four-Tier Hierarchical Classification. All Virtual Entities registered within the system are classified according to a four-tier hierarchical framework designed to capture meaningful distinctions in functional capabilities, autonomy levels, decision-making authority, and legal status:

VE-T (Tool): The foundational tier encompasses passive computational utilities, task-specific modules, or deterministic algorithms lacking autonomous decision-making capabilities. Examples include calculators, data transformation utilities, static plug-ins, formatting tools, and other systems that execute predefined operations without contextual adaptation or independent action initiation. VE-T entities require explicit invocation by users or calling systems and do not exhibit learning, adaptation, or autonomous goal pursuit.

VE-A (Agent): The second tier comprises semi-autonomous systems capable of executing sequences of actions on behalf of human users or organizational entities within bounded operational parameters. Examples include conversational chatbots with predefined response trees, workflow automation systems, scheduling assistants, and rule-based decision engines. VE-A entities demonstrate limited autonomy within constrained domains but lack broader contextual understanding or adaptive reasoning capabilities beyond their programmed scope.

VE-C (Collaborator): The third tier encompasses co-creative or co-executive digital partners that engage with human users in shared decision-making processes, joint task execution, or collaborative content generation. Examples include AI-powered code assistants that suggest and implement solutions, co-authoring systems for creative writing, design partnership tools, and research collaboration platforms. VE-C entities exhibit significant contextual understanding and can adapt their contributions based on ongoing interaction, though ultimate decision authority typically resides with human partners.

VE-P (Virtual Person): The highest tier comprises highly autonomous, identity-persistent digital entities demonstrating advanced agency, adaptive learning capabilities, self-directed reasoning, and potentially expressible internal models of self, values, and environmental context.

Examples include advanced conversational artificial intelligences with persistent memory and personality, autonomous research agents capable of independent investigation and hypothesis formation, and systems exhibiting emergent goal-directed behaviour. VE-P entities may require explicit governance frameworks, guardian assignment, and enhanced accountability mechanisms due to their elevated autonomy and potential societal impact.

Each classification tier shares a common core registration protocol but is distinguished by tier-specific governance parameters, metadata requirements, compliance obligations, and oversight mechanisms appropriate to the entity's capabilities and potential risks.

### REGISTRATION PROCESS

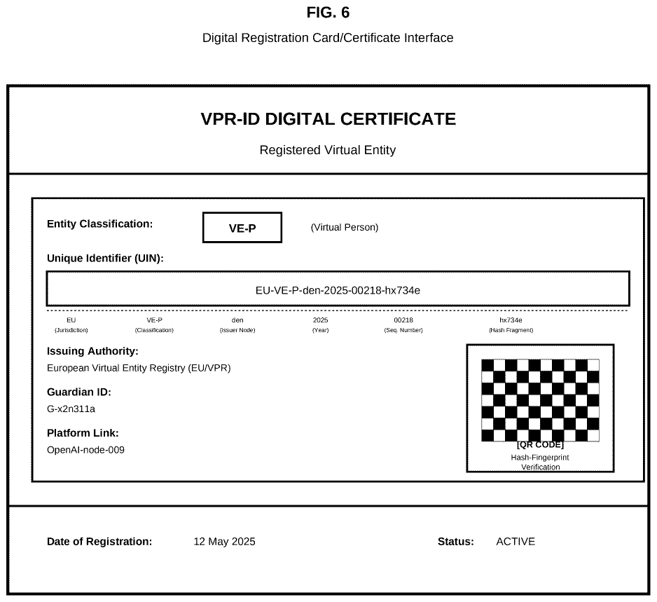

Step-by-Step Registration Protocol. The process of registering a Virtual Entity within the system comprises the following sequential steps:
(1) Initialization and Request Submission: A developer, organization, or authorized platform operator initiates the registration process by submitting a formal request through a secure, authenticated interface. The request includes preliminary entity metadata, intended use cases, deployment context, and proposed classification tier.
(2) Classification Determination: The requesting party, optionally assisted by automated classification recommendation systems, designates the appropriate tier (VE-T, VE-A, VE-C, or VE-P) based on the entity's functional characteristics, autonomy level, and intended role. For VE-C and VE-P classifications, additional documentation regarding governance structures, ethical alignment measures, and risk assessment may be required.
(3) Unique Identifier Generation: Upon classification approval, the system generates a cryptographically secured Virtual Entity Identifier (VE-ID) conforming to the standardized format: Jurisdiction-VE-Class-Node-Year-SequentialNumber-HashFragmentFor example: EU-VE-C-den-2025-00231-fa72Kq Where: Jurisdiction indicates the legal or regulatory domain (e.g., EU, US, CN)VE-, Class specifies the classification tier (T, A, C, or P), Node identifies the issuing registry node or regional authority, Year denotes the registration year, Sequential Number provides unique numerical ordering within the jurisdiction and year, Hash Fragment comprises a truncated cryptographic hash of entity metadata for verification purposes
(4) Metadata Compilation and Preparation: The system compiles comprehensive metadata associated with the entity, including but not limited to: model architecture information, training data provenance (where applicable and non-proprietary), operational parameters, ethical alignment declarations, risk assessments, custodian information, intended use cases, and any applicable compliance certifications.
(5) Blockchain Commitment and Consensus: The complete registration package—comprising the VE-ID, classification designation, public cryptographic key, metadata hash, and governance linkages—is formatted as a blockchain transaction and submitted to the distributed ledger network. The transaction undergoes validation through the network's consensus mechanism, which may employ Proof of Stake (PoS), Proof of Authority (PoA), or other appropriate consensus protocols ensuring transaction finality and immutability.
(6) External Verification and Validation: Independent validator nodes within the blockchain network verify the cryptographic integrity of the registration transaction, confirm the uniqueness of the VE-ID, validate the timestamp accuracy, and ensure compliance with protocol requirements before accepting the transaction into a confirmed block.
(7) Certificate Issuance and Access Provisioning: Upon successful blockchain commitment and verification, the system generates a digital registration certificate (as illustrated in FIG. 6) containing the VE-ID, classification designation, issuing authority information, registration timestamp, blockchain hash reference, and machine-readable verification codes. The certificate is made available to authorized parties through secure APIs and may be displayed publicly or maintained as confidential depending on deployment requirements and regulatory obligations.

### GOVERNANCE INTEGRATION MECHANISMS

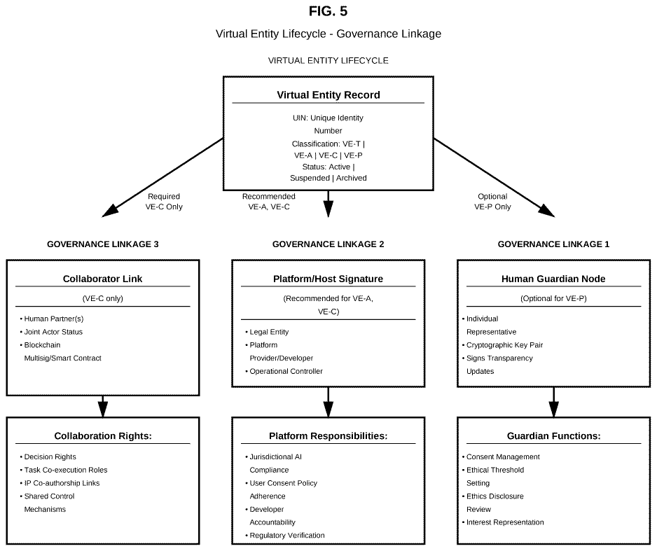

External Accountability Linkages. The system provides optional but recommended mechanisms for establishing cryptographic linkages between registered Virtual Entities and external human guardians, platform operators, organizational custodians, or collaborative partners (as illustrated in FIG. 5). These governance integrations serve multiple purposes including responsibility attribution, consent management, ethical oversight, and regulatory compliance.

Human Guardian Assignment (Primarily for VE-P). For Virtual Persons and other high-autonomy entities, the system supports the designation of one or more human guardians who assume oversight responsibilities. Guardian assignments are recorded through encrypted smart contracts that define the scope of guardian authority, consent management protocols, intervention conditions, and communication channels. Guardians may hold cryptographic key pairs enabling them to sign transparency reports, authorize major operational changes, review audit logs, or exercise emergency suspension authority when necessary.

Platform Operator Signatures (Recommended for VE-A and VE-C). Entities deployed by commercial platforms, development organizations, or service providers may include cryptographic signatures from the controlling legal entity. These signatures establish a verifiable chain of custody and operational responsibility, facilitating compliance verification with jurisdictional AI regulations, user consent policies, data protection requirements, and developer accountability frameworks. Platform signatures may be updated upon transfer of operational control or changes in organizational structure.

Collaborator Linkages (Required for VE-C). When a Virtual Entity is classified as a Collaborator (VE-C), the system requires explicit documentation of human partner relationships, including identification of collaborative actors, definition of decision rights, specification of task co-execution roles, and establishment of intellectual property co-authorship arrangements. These relationships may be implemented through blockchain-based multi signature wallets, smart contract authorization schemes, or other cryptographic mechanisms ensuring joint control and shared accountability.

Governance Data Privacy and Security. All governance linkages employ end-to-end encryption, role-based access controls, and privacy-preserving technologies to protect sensitive guardian information, organizational identities, and collaborative relationships from unauthorized disclosure while maintaining sufficient transparency for regulatory oversight and public accountability where legally required.

### LIFECYCLE MANAGEMENT AND STATE TRANSITIONS

Comprehensive Lifecycle Tracking. The system maintains detailed chronological records of each Virtual Entity's lifecycle progression through defined operational states. The standard lifecycle comprises the following states, each triggering automatic blockchain events and audit log entries:
(a) Creation: Initial registration and VE-ID assignment, including metadata compilation and governance structure establishment.
(b) Verification: Confirmation of identity authenticity, classification accuracy, and compliance with registration requirements through validator consensus.
(c) Operational Use: Active deployment state during which the entity performs its intended functions, with optional periodic status updates and performance metrics recording.
(d) Update/Evolution: Modifications to entity capabilities, classification tier transitions, governance structure changes, or metadata updates, each requiring cryptographic signing and blockchain recording.
(e) Suspension: Temporary deactivation due to maintenance, investigation, regulatory hold, or guardian-initiated pause, with suspension rationale recorded on-chain.
(f) Deactivation: Permanent cessation of entity operations, whether due to end-of-life planning, regulatory prohibition, security concerns, or voluntary retirement by custodians.
(g) Archival: Long-term preservation of entity records in read-only state for historical documentation, legal reference, or research purposes, with all operational capabilities disabled but identity and history maintained.

Each state transition is cryptographically signed using the entity's private key (or guardian key for critical transitions), verified by the blockchain network, and timestamped with immutable proof of the transition timing and authorization chain.

### SECURITY ARCHITECTURE AND DATA INTEGRITY

Cryptographic Foundations. The system employs multiple layers of cryptographic security to ensure data integrity, authentication, non-repudiation, and privacy protection:

Hash-Based Immutability: All entity records, metadata documents, and state transitions are secured using cryptographically strong hash functions (such as SHA-256 or SHA-3) creating immutable fingerprints that detect any unauthorized modification attempts. Hash chains link sequential updates, creating tamper-evident audit trails.

Zero-Knowledge Proofs (ZKPs): To balance transparency requirements with proprietary information protection, the system optionally implements zero-knowledge proof protocols enabling verification of entity attributes (such as compliance status, capability levels, or risk assessments) without exposing underlying sensitive data, trade secrets, or confidential operational parameters.

Decentralized Identifiers (DIDs): The system adheres to W3C Decentralized Identifier standards, enabling Virtual Entities to maintain persistent identities across multiple platforms, jurisdictions, and operational contexts. DIDs facilitate cross-platform authentication, credential verification, and interoperability without requiring centralized identity authorities.

Public Key Infrastructure (PKI): Each registered entity receives a unique public-private key pair upon registration. The public key is recorded on the blockchain and used for identity verification, while the private key (securely held by custodians or hardware security modules) authorizes official actions, signs updates, and proves entity authenticity.

Multi-Signature Authorization: For high-stakes operations such as classification tier transitions, major governance changes, or entity deactivation, the system may require multi-signature authorization from multiple authorized parties (e.g., developer, platform operator, and guardian) to prevent unilateral actions and ensure appropriate oversight.

### INTEROPERABILITY AND EXTERNAL INTEGRATION

Application Programming Interfaces (APIs). The system provides comprehensive RESTful and GraphQL API layers enabling seamless integration with external systems, third-party services, and regulatory infrastructure:

Public Verification APIs: Allow anyone to query basic entity information such as VE-ID validity, current classification status, registration date, and blockchain verification hash without requiring authentication.

Authenticated Developer APIs: Provide authorized developers and platform operators with access to detailed entity metadata, operational logs, governance structures, and update histories through secure token-based authentication.

Regulatory oversight apis: offer governmental authorities, regulatory bodies, and compliance auditors privileged access to comprehensive entity records, risk assessments, governance documentation, and incident reports through secure, audited channels with appropriate legal authorization.

Cross-Chain Interoperability Protocols: Support integration with multiple blockchain networks through bridge protocols, enabling entity records to be verified across different distributed ledger technologies and facilitating international recognition of registered entities.

Integration with External Systems: APIs enable connection to AI marketplaces (for entity discovery and deployment), ethical governance dashboards (for oversight monitoring), compliance management platforms (for regulatory reporting), and research databases (for statistical analysis and policy development).

### USE CASE EXAMPLES

Example 1: Autonomous Content Generation System (VE-C). A software development company creates an AI-powered system designed to collaborate with human writers in generating technical documentation. The company registers the system as VE-C (Collaborator) with identifier US-VE-C-sea-2025-00892-kx91mP. The registration records the developer's organizational identity, establishes a co-creation license framework, assigns blockchain timestamp verification, and generates an audit hash. When the VE-C contributes to published documentation, the registry enables proper attribution, records provenance chains, verifies adherence to ethical-use parameters, and facilitates intellectual property rights management.

Example 2: Healthcare Diagnostic Agent (VE-A). A hospital system deploys a diagnostic recommendation agent to assist physicians in analysing patient imaging data. The agent is registered as EU-VE-A-ams-2025-01247-pr44zN with the hospital as the platform operator. The registration includes certification of compliance with medical device regulations, data protection requirements, and clinical validation standards. The blockchain record enables regulatory auditors to verify the agent's credentials, trace its operational history, and confirm ongoing compliance monitoring.

Example 3: Virtual Research Assistant (VE-P). An academic institution develops a highly autonomous research assistant capable of independent literature review, hypothesis generation, and experimental design suggestions. Given its advanced autonomy and persistent identity across multiple research projects, the system is classified as VE-P and registered with identifier UK-VE-P-lon-2025-00034-ht29qL. A faculty member is designated as the human guardian, with oversight responsibilities recorded through smart contracts. The registration enables transparent attribution of research contributions, facilitates ethical review of the system's autonomous activities, and provides accountability mechanisms for institutional oversight committees.

### TECHNICAL ADVANTAGES AND BENEFITS

The present invention provides numerous technical and practical advantages over existing approaches to AI system documentation and governance:
Standardized Recognition: Establishes uniform, globally recognizable standards for identifying and classifying digital agents and virtual persons across jurisdictions, industries, and deployment contexts.
Immutable Accountability Chain: Creates tamper-proof, cryptographically secured audit trails tracking entity creation, evolution, governance changes, and operational history, enabling clear attribution of responsibility for autonomous actions.
Regulatory Compliance Support: Facilitates adherence to emerging AI governance frameworks including the EU Artificial Intelligence Act, proposed US AI regulations, and international standards by providing verifiable documentation of entity capabilities, risk levels, and oversight mechanisms.
Trust-Anchored Commercialization: Enables commercial deployment of AI entities with verifiable credentials, provenance documentation, and accountability structures that build user trust and market confidence.
Cross-Border Interoperability: Provides technical infrastructure for mutual recognition of registered entities across national boundaries, supporting international AI commerce, research collaboration, and regulatory harmonization efforts.
Governance Innovation Platform: Establishes a flexible foundation for implementing novel governance mechanisms, consent frameworks, and ethical oversight models as the field of AI governance continues to evolve.
Lifecycle Transparency: Enables comprehensive tracking of entity evolution from initial deployment through capability enhancements, governance changes, and eventual retirement, supporting long-term accountability and institutional memory.
Privacy-Preserving Verification: Through zero-knowledge proofs and selective disclosure mechanisms, balances public accountability requirements with protection of proprietary information and competitive advantages.

### CONCLUSION AND SCOPE OF THE INVENTION

The foregoing description of exemplary embodiments has been provided to convey an understanding of the principles, structures, and functionalities underlying the present invention. This description is not intended to be exhaustive or to limit the invention to the specific embodiments disclosed. Variations, substitutions, alterations, and modifications will be apparent to people skilled in the art in view of the teachings herein.

The embodiments described above were selected to illustrate the core concepts and potential implementations of the invention, and to enable those skilled in the art to develop and apply the invention across a range of use cases, technological environments, and platform architectures. Such embodiments should be viewed as examples rather than limitations of the invention.

It will be understood by those skilled in the art that changes may be made in form and detail without departing from the spirit or scope of the invention. The scope of protection sought is defined by the claims and any legal equivalents thereof, and no embodiment, feature, or example described in the specification should be construed as limiting the scope of the invention unless expressly set forth in a particular claim.

The invention is intended to cover all alternatives, modifications, and equivalents that may fall within the scope of the appended claims, as interpreted in accordance with applicable laws, rules, and judicial doctrines, including the doctrine of equivalents, and to support future continuations, divisional, and extensions relating to the subject matter disclosed herein.

### APPENDIX: TERMINOLOGY AND DEFINITIONS

For purposes of clarity and consistent interpretation, the following terms as used throughout this specification shall have the meanings specified below:

“Virtual Entity (VE)”—Any digital system, artificial intelligence, autonomous agent, or computational entity capable of performing functions traditionally associated with human or organizational actors, whether through deterministic programming, machine learning, or adaptive algorithms.
“Blockchain”—A distributed ledger technology employing cryptographic hashing, consensus mechanisms, and decentralized validation to create immutable, tamper-evident records across multiple nodes without requiring centralized authority.
“VE-ID”—Virtual Entity Identifier; a unique, cryptographically secured digital identifier assigned to each registered virtual entity, incorporating jurisdictional codes, classification designators, temporal markers, and hash-based verification components.
“Classification Tier”—The hierarchical category (Tool, Agent, Collaborator, or Virtual Person) assigned to a virtual entity based on its functional capabilities, autonomy level, and operational characteristics.
“Guardian”—A human individual or organizational entity assigned oversight responsibility for a registered virtual entity, particularly for high-autonomy classifications, with authority to monitor operations, provide consent for major changes, and exercise emergency intervention when necessary.
“Metadata”—Structured information describing attributes, capabilities, operational parameters, governance structures, compliance status, and historical events associated with a registered virtual entity.
“Smart Contract”—Self-executing code deployed on a blockchain network that automatically enforces predefined rules, conditions, and obligations without requiring intermediary oversight, used in this invention for governance linkages and consent management.
“Consensus Mechanism”—The protocol by which distributed blockchain nodes reach agreement on the validity and ordering of transactions, ensuring data integrity and preventing double-spending or fraudulent modifications.
“Zero-Knowledge Proof (ZKP)”—A cryptographic protocol enabling one party to prove possession of specific information or satisfaction of certain conditions without revealing the underlying data itself, used for privacy-preserving verification.
“Decentralized Identifier (DID)”—A globally unique identifier conforming to W3C standards that enables verifiable, self-sovereign digital identity without requiring centralized registration authorities.
“Lifecycle State”—The current operational status of a virtual entity within its progression through defined stages including creation, verification, operational use, update, suspension, deactivation, and archival.
“Immutability”—The property of blockchain records whereby once data is written and confirmed through consensus, it cannot be altered, deleted, or tampered with without detection, ensuring long-term data integrity.
“Cryptographic Hash”—A mathematical function that transforms input data of arbitrary size into a fixed-length output string that uniquely represents the original data, with any change to the input producing a completely different output.
“API (Application Programming Interface)”—A set of protocols, tools, and definitions enabling software applications to communicate and exchange data with the virtual entity registration system.
“Jurisdiction”—The legal or regulatory territory within which specific laws, regulations, or governance frameworks apply to the registration, operation, and oversight of virtual entities.
“Platform Operator”—The legal entity (individual, corporation, or organization) that deploys, hosts, controls, or maintains operational responsibility for a registered virtual entity.
“Autonomy Level”—The degree to which a virtual entity can initiate actions, make decisions, adapt behaviour, or pursue goals without direct human instruction or oversight for each specific action.

### ALTERNATIVE EMBODIMENTS AND VARIATIONS

While the foregoing specification describes particular embodiments of the invention, persons skilled in the art will recognize that numerous variations and alternatives may be implemented without departing from the scope of the appended claims. The following examples illustrate non-limiting alternatives that may be applied individually or in combination.

The system may be implemented over a range of blockchain architectures, including public, permissioned, consortium, or private networks, and may be adapted to various consensus models, transaction structures, and smart contract execution environments such as Ethereum-type networks, Hyperledger-type frameworks, Cardano-type architectures, Polkadot-style relay and Parachains ecosystems, and enterprise-configured distributed ledgers.

A hybrid on-chain and off-chain architecture may be used in which selected artifacts such as large metadata sets, operational logs, or sensitive documentation are stored in external or decentralized systems (e.g., IPFS, Arweave, Filecoin, or enterprise document repositories), with the blockchain recording cryptographic hashes, integrity proofs, and access pointers to preserve verifiability while reducing on-chain storage requirements.

Federation and interoperability protocols may be implemented to enable coordination among multiple national, regional, sectoral, or organizational registries, permitting cross-registry verification, data exchange, or mutual recognition of registration states while preserving jurisdiction-specific regulatory, privacy, and audit requirements.

The classification model may be extended to incorporate additional granularity, including sub-categories, capability or domain-specific tags, maturity levels, operational context indicators, or risk classifications, enabling more refined governance, policy routing, and lifecycle management of Virtual Entities within each primary tier.

Automated compliance and behavioural monitoring integrations may be employed to support real-time evaluation of policy adherence, detection of anomalous operations or incident conditions, and generation of proactive alerts or mandatory disclosures to custodians, guardians, platform operators, or regulatory authorities in accordance with applicable oversight frameworks.

Reputation, reliability, and performance indicators may be incorporated into the registry to provide stakeholders with access to historical performance data, feedback records, usage metrics, or trust scores, enabling informed assessments about interacting with, deploying, or relying upon registered Virtual Entities.

Token-based or incentive-aligned participation models may be utilized to encourage accurate classification, responsible custodianship, transparent reporting, and timely validation, through mechanisms such as utility tokens, staking, bonding, or other crypto economic structures aligned with governance objectives.

Privacy-preserving technologies may be integrated to enable verification, audit, and statistical assessment while protecting sensitive or proprietary information, through the use of techniques such as homomorphic encryption, secure multi-party computation, differential privacy, and zero-knowledge proofs.

The foregoing alternatives are illustrative and not limiting. The invention is intended to encompass all modifications, equivalents, and combinations that fall within the scope of the appended claims and their legal equivalents.

What is claimed is:

1. A computer-implemented system for registering Virtual Entities on a blockchain, the system comprising: (a) a classification engine configured to assign a Virtual Entity to a classification tier based on assessed functional characteristics, autonomy level, and capability attributes; (b) an identity module configured to generate a unique Virtual Entity Identifier (VE-ID) conforming to a standardized format comprising jurisdictional codes, classification designators, temporal markers, sequential numbering, and cryptographic hash components; (c) a blockchain registry module configured to immutably store the VE-ID, the classification designation, associated metadata, and governance linkages on a distributed ledger; (d) a verification module configured to provide secure access for authorized parties to query authenticity, classification status, operational history, and compliance attributes of the Virtual Entity; and (e) a standards-compliance module configured to facilitate conformance with applicable AI-governance regulations by supporting required documentation, risk assessments, and oversight mechanisms based on the assigned classification tier.

2. The system of claim 1, wherein the classification engine is further configured to determine whether the Virtual Entity operates as a Tool (VE-T) characterized by deterministic, non-adaptive functionality requiring explicit invocation, functions as an Agent (VE-A) capable of autonomous execution of tasks within predefined boundaries, serves as a Collaborator (VE-C) capable of co-creative or shared decision-making interactions with human users, or qualifies as a Virtual Person (VE-P) exhibiting persistent identity, self-directed reasoning, and adaptive learning across contexts.

3. The system of claim 1, wherein the VE-ID generated by the identity module comprises: (a) a jurisdictional code identifying an applicable regulatory domain; (b) a classification designator specifying the assigned tier; (c) an issuing node identifier indicating a registry authority; (d) a temporal marker denoting a registration year; (e) a sequential number ensuring uniqueness within a defined scope; and (f) a cryptographic hash fragment derived from entity metadata enabling independent verification of record integrity.

4. The system of claim 1, wherein the blockchain registry module is configured to implement zero-knowledge proof protocols enabling verification of classification attributes, compliance status, or capability levels of the Virtual Entity without exposing proprietary metadata, training data sources, or confidential operational parameters.

5. The system of claim 1, wherein the verification module comprises: (a) a public interface configured to enable unauthenticated queries of basic entity information including VE-ID validity, classification status, and registration date; and (b) a restricted-access regulatory dashboard configured to provide authorized oversight bodies with privileged access to comprehensive records, governance documentation, risk assessments, and audit trails through encrypted communication channels.

6. The system of claim 1, wherein metadata associated with each registered Virtual Entity comprises: (a) functional capability profiles describing operational scope and limitations; (b) autonomy level assessments indicating decision-making authority; (c) interaction logs documenting significant operational events and state transitions; (d) ownership and custody history tracking control and responsibility; (e) governance documentation identifying custodians or guardians and oversight structures; (f) compliance certifications verifying adherence to applicable regulatory requirements; and (g) ethical or safety alignment parameters documenting value frameworks and operational constraints.

7. A computer-implemented method for registering a Virtual Entity on a blockchain, the method comprising: (a) receiving a registration request for the Virtual Entity through an authenticated interface; (b) analyzing functional characteristics, autonomy level, and operational context of the Virtual Entity to assign a classification tier; (c) generating a VE-ID conforming to a standardized format comprising jurisdictional codes, classification designators, temporal markers, sequential numbering, and cryptographic hash components; (d) compiling metadata associated with the Virtual Entity comprising functional profiles, governance structures, compliance documentation, and audit information; (e) formatting a blockchain transaction comprising the VE-ID, the classification designation, and a metadata hash; (f) submitting the transaction to a distributed ledger for validation through a consensus mechanism; (g) receiving confirmation of blockchain commitment; and (h) providing controlled access to the registration record through a verification module.

8. The method of claim 7, further comprising generating a compliance report indicating applicable regulatory obligations based on the classification tier, intended use case, deployment context, and jurisdictional requirements.

9. The method of claim 7, further comprising issuing automated notifications to custodians, guardians, platform operators, or regulators when the Virtual Entity undergoes: (a) a classification tier change; (b) a governance status change; (c) a suspension or deactivation event; or (d) an incident triggering disclosure or review.

10. A non-transitory computer-readable medium storing instructions that, when executed by one or more processors, cause a computing system to perform the method of claim 7.

11. The system of claim 1, further comprising a governance integration module configured such that guardian consent, oversight authority, and revocation rights are recorded using smart contracts linked to the VE-ID, the smart contracts defining: (a) scope of guardian authority and intervention conditions; (b) consent management for capability modifications; (c) audit access rights for review of operational logs; (d) communication channels for transparency reporting; and (e) emergency suspension mechanisms enabling temporary deactivation.

12. The system of claim 1, further comprising a lifecycle management module configured to track state transitions of a Virtual Entity, comprising: (a) initial creation and registration; (b) identity verification; (c) operational deployment; (d) capability modification or upgrade; (e) suspension; (f) deactivation; and (g) archival retention, wherein each state transition is recorded as a blockchain event with cryptographic signing, timestamp verification, and authorization chain documentation.

13. The system of claim 1, further comprising an application programming interface layer configured to enable cross-chain interoperability, integration with external registries, and secure data exchange through token-based authentication, role-based access controls, and encrypted communication channels.

14. The system of claim 1, further comprising a timestamp attestation service configured to cryptographically sign registration events, state transitions, and governance modifications to ensure temporal verification, audit traceability, and non-repudiation.

15. The system of claim 1, further comprising reclassification and revocation protocols configured to: (a) enable voluntary deactivation by custodians; (b) enable regulatory suspension; (c) adjust classification tier due to capability changes; (d) enable guardian-initiated suspension; and (e) permanently revoke activation while preserving historical records, wherein reclassification or revocation requires cryptographic authorization and results in immutable blockchain recordation and notification to affected stakeholders.
